(19) United States
(12) Patent Application Publication
(10) Pub. No.: US 2002/0156827 A1
(43) Pub. Date: Oct. 24, 2002

(54) Archival system for personal documents

(76) Inventor: Avraham Lazar, Tel Aviv (IL)

Correspondence Address: Y. ROCKY TSAO, Fish & Richardson P.C., 225 Franklin Street, Boston, MA, 02110-2804, US

(21) Appl. No.: 09/832,540

(22) Filed: Apr. 11, 2001

(51) Int. Cl. G06F 15/16

(52) U.S. Cl. 709/201; 709/217

(57) ABSTRACT

A system and method for archiving personal documents in a remote location. Preferably, the documents are indexed and retrieved based on index words which may be embedded in the document, submitted as auxiliary data, or selected from a menu. Preferably, the software intensive elements of archiving system are installed at the remote location. The remote archiving service in a preferred embodiment is offered by an application service provider. An apparatus for capturing and feeding a document to a remote archiving system, according to a preferred embodiment is also described.

### FIELD AND BACKGROUND OF THE INVENTION

The modern household deals with a large number of documents in printed or hand written forms that should be filed and occasionally retrieved. Misplacement of a document, loss or damage to a document that is the only copy, or inaccessibility of a document when and where required, may have grave consequences.

Presently, an individual wanting to do more than simply filing the hard copies, can scan documents and store the image files on his own memory device such as a hard drive of a personal computer. However, the files take up valuable memory. In addition, the process of indexing the image files to facilitate retrieval requires extra effort on the part of the individual. For example, the individual can create folders and subfolders for different types of documents, or the individual can group certain documents on a diskette which has the appropriate label marked on it, or the individual can implement a full featured database structure. Such environments for local storage and management of scanned documents require that the user be capable of handling sophisticated information technologies, performing periodic backups, dealing with redundancy and reliability aspects, etc.

For the high-end, sophisticated enterprise customers, there are companies which offer solutions to document management (see for example www.kofax.com), and companies which offer internet based, centralized document storage and retrieval services (see for example www.imagesilo.com).

For individual users, there are some non-web based personal archiving systems (see for example www.mydocuments.com) that offer limited options to the individual consumer. These systems offer an environment for orderly storage on the user's local disk, with limited accessibility over the Internet. There are, also, some web sites targeted at individual consumers, which allow centralized storage and retrieval of on line photo albums (see for example www.cartogra.com).

It is an object of the invention to provide a system and method for archiving personal documents at a remote storage site.

It is another object of the invention to provide a system and method for capturing personal documents for storage.

It is yet another object of the invention to provide a system and method for indexing, images of personal documents,

It is yet another object of the invention to provide a system and method for retrieving archived images of personal documents.

It is yet another object of the invention to provide these capabilities on a service basis to consumers, having all or most of the algorithms and software intensive elements installed at a central facility (facilities) where they are centrally managed and maintained by the personnel of the service provider.

It is yet another object of the invention to provide an archiving apparatus.

### SUMMARY OF THE INVENTION

According to the present invention there is provided a method for preparing at least one personal document for remote archiving, including the steps of: associating a least one index word with the at least one personal document; and transmitting at least one file related to the at least one personal document to a remote storage location.

According to the present invention there is also provided, a method for remotely archiving at least one personal document, including the steps of: receiving from a remote site at least one file related to the at least one personal document; associating at least one index word with the at least one file; and storing the at least one file.

According to the present invention, there is still further provided, a method for requesting the retrieval of at least one remotely archived file related to a personal document, including the steps of: specifying at least one index word; and receiving the at least one file associated with the at least one specified index word.

According to the present invention, there is still further provided, a method of retrieving at least one remotely archived file, related to at least one personal document, including the steps of: receiving at least one index word associated with the at least one remotely archived file; retrieving the at least one remotely archived file from storage; and transmitting the retrieved at least one file.

According to the present invention there is provided a system for remotely archiving at least one personal document, including: at least one processing element for associating at least one index word with at least one file related to the at least one personal document; and at least one storage element for storing the at least one file based on the associating.

According to the present invention, there is also provided, a system for preparing at least one personal document for remote archiving, including: at least one communication interface; and at least one device for specifying at least one index word associated with the at least one document, coupled to the at least one communication interface.

According to the present invention, there is still further provided, a system for retrieving at least one remotely archived file related to at least one personal document, including at least one storage element for storing the at least one file related to the at least one personal document; and at least one searching element for searching the at least one storage element for the at least one file.

According to the present invention, there is still further provided, a system for requesting the retrieval of at least one remotely archived file related to at least one personal document, including: at least one communication interface; and at least one device coupled to the at least one communication interface for specifying at least one index word associated with the at least one document.

According to the present invention, there is provided a method of providing a remote archiving service to individual users by an application service provider, including the steps of: users registering for remote archiving service; users using remote archiving service; and users being billed based on their usage.

According to the present invention, there is provided an apparatus for capturing and feeding a document to a remote archiving system, including a controller; and a scanner module coupled to the controller. Optionally, an indexing module may also be coupled to the controller.

### BRIEF DESCRIPTION OF THE DRAWINGS

The invention is herein described, by way of example only, with reference to the accompanying drawings, wherein:

FIG. 1 is a generalized block diagram of the general architecture of the system according to an embodiment of the present invention;

FIG. 2a shows a generalized block diagram of a scanning system according to one embodiment of the invention;

FIG. 2b shows a generalized block diagram of a scanning system according to another embodiment of the invention;

FIG. 2c shows a generalized block diagram of a scanning system according to another embodiment of the invention;

FIG. 2d shows a generalized block diagram of a scanning system according to another embodiment of the invention;

FIG. 2e shows a generalized block diagram of a scanning system according to another embodiment of the invention;

FIG. 2f shows a generalized block diagram of a scanning system according to another embodiment of the invention;

FIG. 2g shows a generalized block diagram of a scanning system according to another embodiment of the invention;

FIG 3 shows a block diagram of an archiving device according to an embodiment the present invention;

FIG. 4a shows a scheme for associating index words with documents using keywords as embedded data according to an embodiment of the present invention;

FIG. 4b shows a scheme for associating index words with documents using highlighted embedded data according to an embodiment of the present invention;

FIG. 4c shows a scheme for associating index words with documents using location-sensitive embedded data according to an embodiment of the present invention;

FIG. 5a shows a scheme for associating index words with documents using manually keyed-in auxiliary data according to an embodiment of the present invention;

FIG. 5b shows a scheme for associating index words with documents using auxiliary data scanned separately from the original document according to an embodiment of the present invention;

FIG. 5c shows a scheme for associating index words with documents using voice annotation as auxiliary data according to an embodiment of the present invention;

FIG. 6 shows a scheme for associating index words with documents that is menu driven according to an embodiment of the present invention;

FIG. 7 shows a scheme for associating index words with documents that is off-line according to an embodiment of the present invention;

FIG. 8 illustrates a retrieval method according to an embodiment of the present invention;

FIG. 9a shows a retrieval system according to an embodiment of the present invention;

FIG. 9b shows a retrieval system according to an embodiment of the present invention.

FIG. 9c shows a retrieval system according to an embodiment of the present invention;

FIG. 9d shows a retrieval system according to an embodiment of the present invention;

FIG. 9e shows a retrieval system according to an embodiment of the present invention;

FIG. 9f shows a retrieval system according to an embodiment of the present invention; and

FIG. 9g shows a retrieval system according to an embodiment of the present invention.

### DESCRIPTION OF THE PREFERRED EMBODIMENTS

The present invention is of a system and method of capturing, indexing, storing and retrieving all types of personal documents. The method and/or system can also include a novel archiving apparatus. Specifically, the present invention is used to store personal documents at a remote location.

“Personal Documents” is used hereinafter to refer to documents that are mainly for individual use (rather than company use), and include at least one alphanumeric character. Principles and operation of a personal documents archival system and method according to a preferred embodiment of the present invention may be better understood with reference to the drawings and the accompanying description.

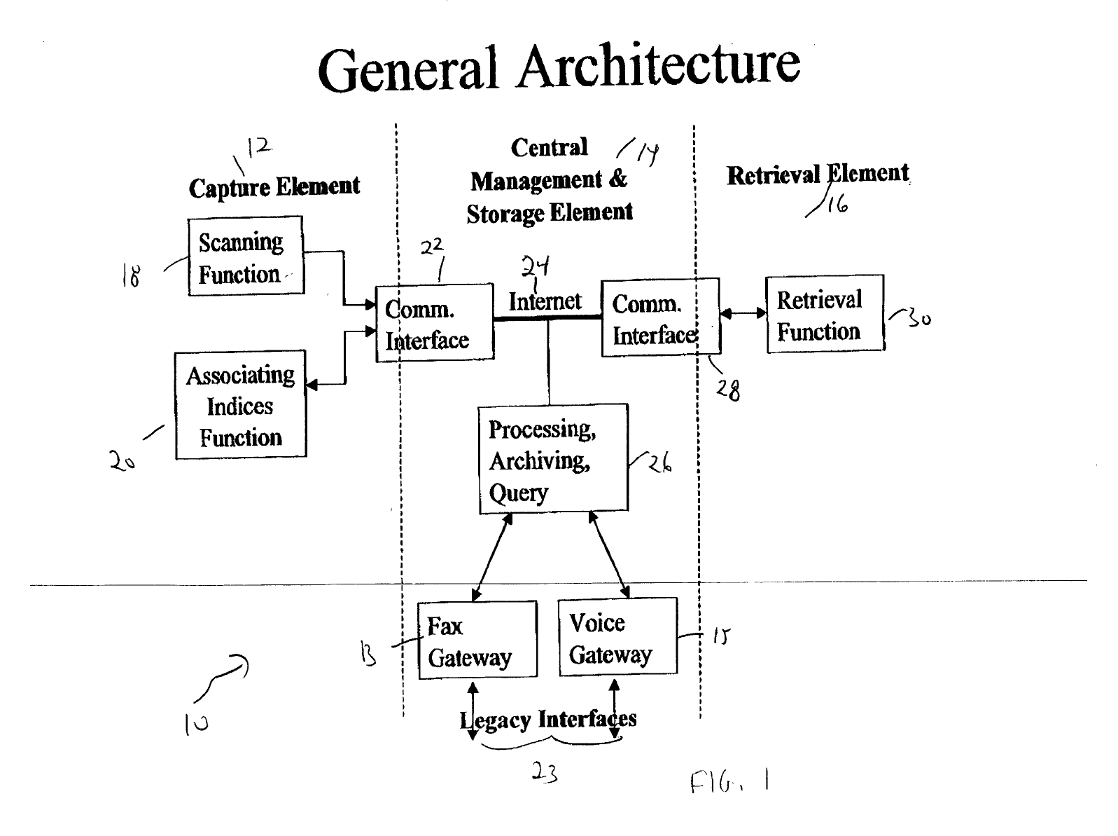

Referring now to FIG. 1, there is shown the general architecture of an archival system 10. System 10 includes three main components: One or more capture elements 12, a central management and storage element CMSE 14 and one or more retrieval elements 16. A communication interface 22 provides a connection between one or more capture elements 12 and CMSE 14. A communication interface 28 provides a connection between CMSE 14 and one or more retrieval elements 16.

One or more capture elements 12 are configured to perform a scanning function 18 and an index associating function 20 (i.e. specifying one or more indices corresponding to the scanned document). It should be evident that certain documents may not need to be scanned to produce an image file as a user may receive the image file of those documents in other ways. For example, a user may download an image file of his bank statement directly from his bank's web site. Alternatively, a user may receive a soft-copy version of a statement. In such cases, scanning function 18 is replaced by a more general “obtaining image file” function.

The “obtaining image file” function may be performed manually, i.e. when specifically requested by the user, or alternatively may be done automatically at a user defined schedule (for example, a weekly download of a bank statement), or may be done upon certain user defined condition being met (for example, download of a stock portfolio on broker's web site when a change is identified in a certain stock). The downloaded page is directly sent to storage at the CMSE 14, or alternatively to the user for later transmittal to CMSE 14. Preferably, if the downloaded page is directly sent for storage at CMSE 14, pre-assigned index words based on the defined condition are sent with the page. The identification of the occurrence of the user defined condition may necessitate an appropriate monitoring function to be incorporated in CMSE 14 or at the capture element site. It should be noted that the invention is not bound by any particular scheme for associating indices with documents.

Reverting now to FIG. 1, CMSE 14 is configured to perform processing, archiving and query function 26. CMSE 14 performs both central management and storage. The device for central management is preferably located at the same location as the remote storage device, i.e. the physical location of the memory. However, the device for central management can also be located at a distance from the storage element as long as there is a data link between the central management device and storage element. Moreover, the central management function can be distributed over more than one device and/or location, and the storage function can be distributed over more than one element and/or location.

One or more retrieval elements 16 are configured to perform retrieval function 30. One or more retrieval elements 16 may or may not be identical with one or more capture elements 12, and communication interfaces 22 and 28 may or may not be identical to each other.

Communication interfaces 22 and 28 are shown here to connect to the Internet 24 and thereby to CMSE 14. Alternatively, legacy interfaces 23 provide interfaces via a fax gateway 13 and/or a voice gateway 15 to CMSE 14.

Communication interfaces 22 and 28 can connect to internet 24 through POTS (plain old telephone system), ISDN, xDSL, cable, wireless, satellite, etc. However, communication means other than the internet for intercommunication between one or more capture elements 12 and/or one or more retrieval elements 16 are within the scope of the invention.

Integration to other communication means may be implemented either by complying with other standards and protocols, or through gateway elements at CSME 14. For example, a document image may be sent to the CSME 14 by fax, where it will be processed through fax gateway 13 and routed to the IP network for further processing.

Alternatively, voice gateway 15 allows for storage of voice (including converted voice-to-text) files instead of or in addition to the storage images of a document. Voice gateway 15 performs the function of converting voice (possibly receiving it through a telephony system, for example) to text for storage. The voice includes oral recitations of at least part of the contents of the document (the document including at least one alphanumeric character). A speech to text product is exemplified by IBM's ViaVoice Gold and Simply Speaking Gold products. This scenario is envisioned as being particularly suitable for situations in which a personal document includes a small amount of simple data—for example an index card comprising of a name (which might be orally spelled out character by character) and a telephone number. Alternatively, the voice is digitized and archived as a digital voice file (i.e. no conversion to text performed), which may be played back later in the voice retrieval mode. The voice (including converted voice-to text) files can be indexed in a later session as in FIG. 7.

It should be evident that the configuration of communication interfaces 22 and 28 may differ based on the communication means in use. In some of the examples outlined above communications interfaces 22 and/or 28 might comprise dedicated hardware and software (as in the case of a modem and appropriate drivers in a PC, for example), but in other cases the whole communications interface 22 and/or 28 might be an integral, embedded part of the device being used (as in the case of a web enabled cellular phone using a WAP protocol, for example).

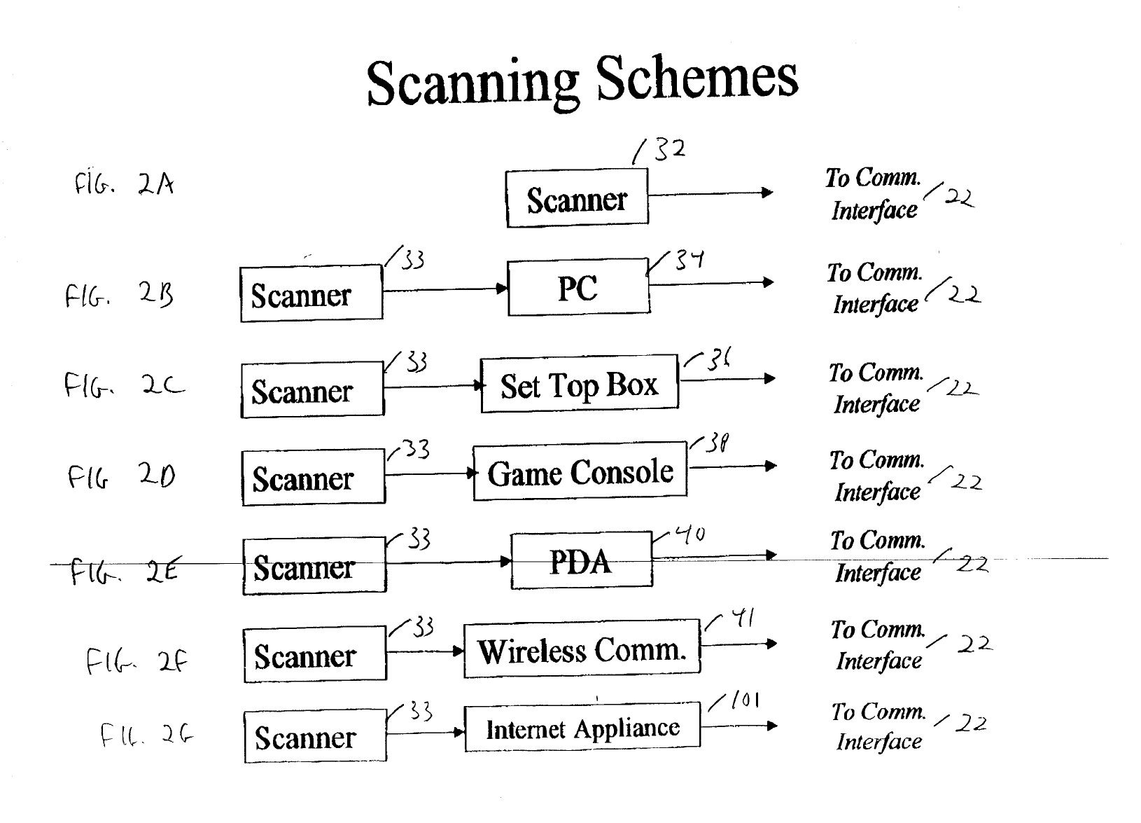

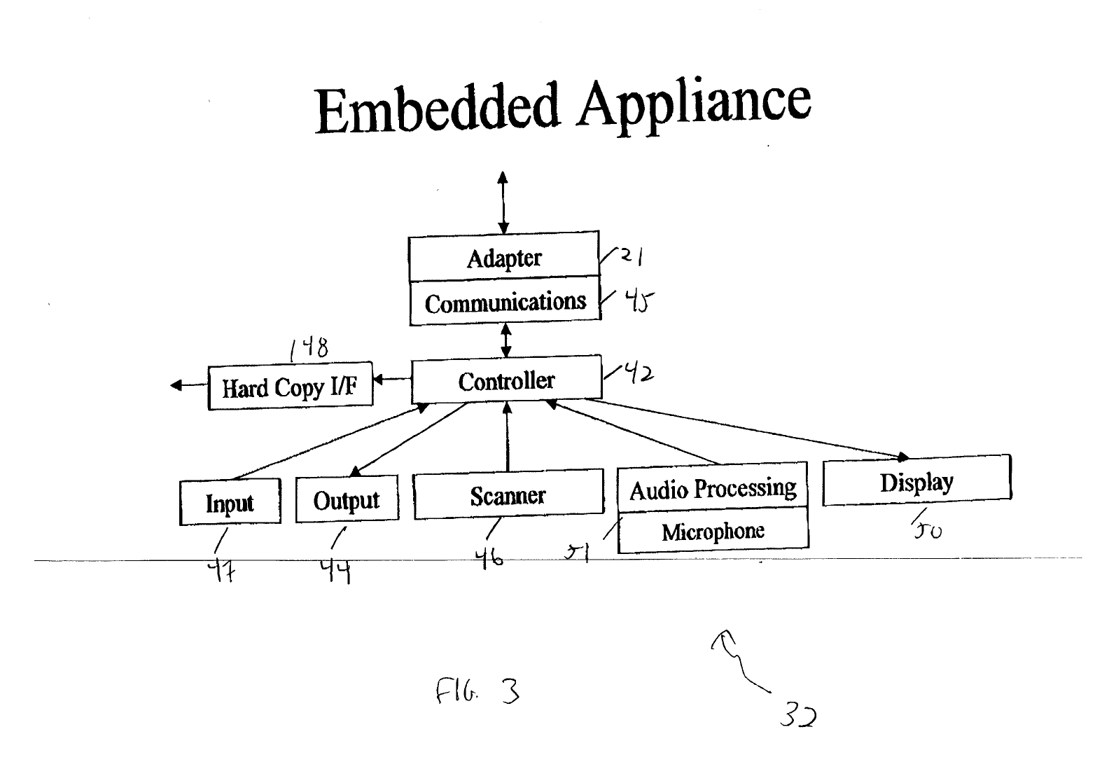

FIGS. 2a-2f show typical yet not exclusive configurations for scanning function 18 performed by one or more capture elements 12. In FIG. 2a an archiving device 32, including its own controller 42, is directly connected to communication interface 22. Alternatively device 32 can have a communications interface 45 built in (see FIG. 3). In FIG. 2b, a scanner 33, which does not need to include its own controller, is connected as a peripheral to a personal computer (PC) 34 which is connected to communication interface 22. In FIG. 2c, scanner 33 is connected as a peripheral to set top box 36 which is connected to communication interface 22. In FIG. 2d, scanner 33 is connected as a peripheral to game console 38 which is connected to communication interface 22. In FIG. 2e, scanner 33 is connected as peripheral to personal digital assistant (PDA) 40 which is connected to communication interface 22. In FIG. 2f, scanner 33 is connected to a wireless device 41, such as a cellular phone. In FIG. 2g, scanner 33 is connected to a Network Appliance 101. In FIGS. 2b-2g, the connection between scanner 33 and devices 34 to 41 or 101 may be a physical connection through wires or the connection may be wireless, for example using the Bluetooth protocol.

FIG 3 shows a block diagram of archiving device (or as sometimes termed below “apparatus for capturing and feeding a document to a remote archiving system”) 32. The purpose of the device is to streamline and ease the use of the system from the user's point of view, mainly in the “input” phase—i.e. the scanning/associating indices operation. To achieve this goal, device 32 includes at least a scanner 46 and all the functions (hardware and software) essential for straight forward connection to the Internet—i.e. no need for any additional unit between the scanner (now built-in one) and Internet 24 (such as a computer, a game console, a cellular phone etc.).

Additionally, device 32 may include other optional elements such as: 1) a display 50 (may be used to view the scanned image, to prompt the user for action to display menus, for displaying retrieved documents in retrieve mode, etc.). 2) a built-in microphone 51 and associated voice processing capability to perform voice digitization and possibly local voice to text conversion, 3) an input module 47, used for inputting indices and/or simple commands such as “scan document”, “scan index sheet”, “get audio input from the microphone”, “add input from microphone to list of permitted index words”, “show last inputted index word on the display”, etc., 4) an output module 44—if a display is not implemented, a simple output module (comprising for example of few LED's) may be used to indicate basic status data such as “scanner fault”, “index word not recognized as a legitimate one”, “index word OK”, “no more index words allowed”, etc.

It should be noted that if both input module 47 and display 50 are implemented, a variety of functions may be performed at the local level. For example the scanned image might be displayed, before transmission to CMSE 14, to enable the user to check the scanning quality, the results of local OCR/ICR/Voice-to-text processing (if done) may be displayed to the user, etc. In the latter case local controller 42 may also use the display unit to prompt the user for some activity—for example confirming that the index word derived is accurate, or to indicate a conversion failure, etc.

The main modules of this device (some of which are optional) are presented in FIG. 3 and include:

1. embedded controller 42, performing all the control functions as well the processing that is taking place at the user's site.

2. communications module 45—together with the controller, handles all the communications with CMSE 14 via Internet 24. This module may include an adapter 21 for the specific transport media used—i.e. cable modem, xDSL modem, POTS, cellular, etc. Communications interface 45 might have all the adaptors modules 21 built in, with only one of adaptor modules 21 selected as the active one during device setup. In other embodiments, communications module 45 is not built in and device 32 connects to communications interface 22 (as in FIG. 2a)

3. Scanner module 46—performs scanning of paper inputs—either the scanned document or an index sheet. The scanner module, on its own or together with controller 42, might or might not do some processing on the documents being fed, such as image enhancement, OCR, etc.

4. Audio processing 51—comprises of a microphone and voice digitization circuitry. The audio processing module, on its own or together with the controller, might or might not do some processing on the digitized voice, such as voice to text conversion. The microphone in some embodiments is used for associating indices through voice annotation.

5. Display module 50—may be used for a variety of functions, as described above.

6. Input 47 and output 44 modules—used for simple user interaction, see example above. To support menu-driven associating or indices with documents, the input module might also include a mechanism to select specific index words out of a list displayed on the display module.

7. Hard copy interface 48—interface to an external device such as a printer, for example for obtaining a hard copy of a retrieved document.

Those versed in the art will readily appreciate that the invention is not bound by the specific modules depicted in FIG. 3.

The indices which a user specifies can either be common to all users or individualized for a particular user. A user may specify individualized keywords when signing up i.e. registering (by phone, fax, internet, regular or electronic mail, etc.) for archival system 10, or at a later date as part of a maintenance communication or through other means (by phone, fax, internet, regular or electronic mail, etc).

In addition to the specification of individualized keywords, during sign-up or later maintenance communication, the amount of allocated storage space and retrieval options such as voice retrieval or summary retrieval may be defined for each user.

In certain embodiments, the index words which a user can specify are unlimited. In these cases, CMSE 14 either uses the same index words specified by a user for indexing and storing the documents, or CMSE 14 includes the capabilities of mapping the user-specified indices into a more limited number of words used for indexing and storing the document. CMSE 14 may query a user to ensure the user approves of the positive identification of the index words and/or of the mapping by the CMSE, or to get further instructions in case the CSME does not recognize a received index word as a legitimate one for the particular user. This CMSE/user interaction may take place either in real time or in a later session, in which case the user—through retrieval element 16—will be presented with a list of problem issues requiring his manual intervention. Another example of a problem situation might be when a received document does not initially have any index data associated with it—see more detailed discussion later on.

A user usually specifies more than one index word for a certain document, to enable flexible and efficient retrieval capabilities (for example, a March phone bill could be stored with the associated indices “March”, “bill” and “phone”, and retrieved using “March” and “bills”, or “bills” and “phone”, or “March” and “bills” and “phones”). The corresponding index words that CMSE 14 uses to index and store the documents need not be identical to the indices used by the user. In certain embodiments, more than one user-specified index such as “bank”, “credit union”, “financial institution” may map onto one CMSE 14 index word such as “financial”. The reverse is also true in certain embodiments. For example a user may prefer to use the general index “credit card”, whereas based on the credit card number (for example, automatically extracted by the CMSE from a scanned image using form processing and optical character recognition (OCR) technologies), CMSE 14 may store the image file while adding specific credit card index words such as VISA, MasterCard, etc. An example of form processing technology is FormWare™ manufactured by Captiva Software Corporation, headquartered in San Diego, Calif. OCR technology is exemplified by CharacterEyes® manufactured by Ligature, Ltd, headquartered in Jerusalem, Israel.

Schemes for associating index words with documents described in the following paragraphs may be grouped into 3 major categories:

1. Embedded data—where the index information is derived from the personal document itself (i.e. only the file related to the personal document to be stored needs to be sent to CMSE 14)

2. Auxiliary data—where the index information is provided separately from the file related to the personal document, for example using data keyed in, digitized voice sent to CMSE 14 for voice to text processing, written words scanned and sent to CMSE 14 for OCR/ICR processing, etc

3. Menu selection—where the user is presented with a list of legitimate indices, and selects a subset using a pointing mechanism.

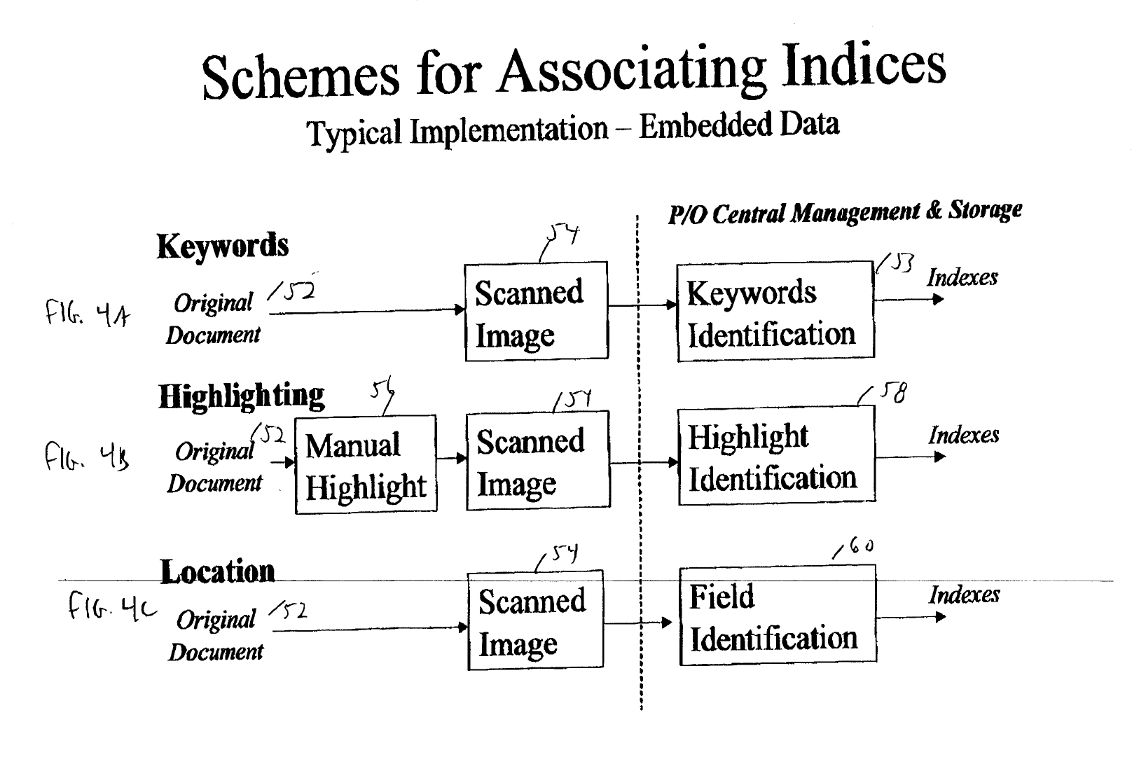

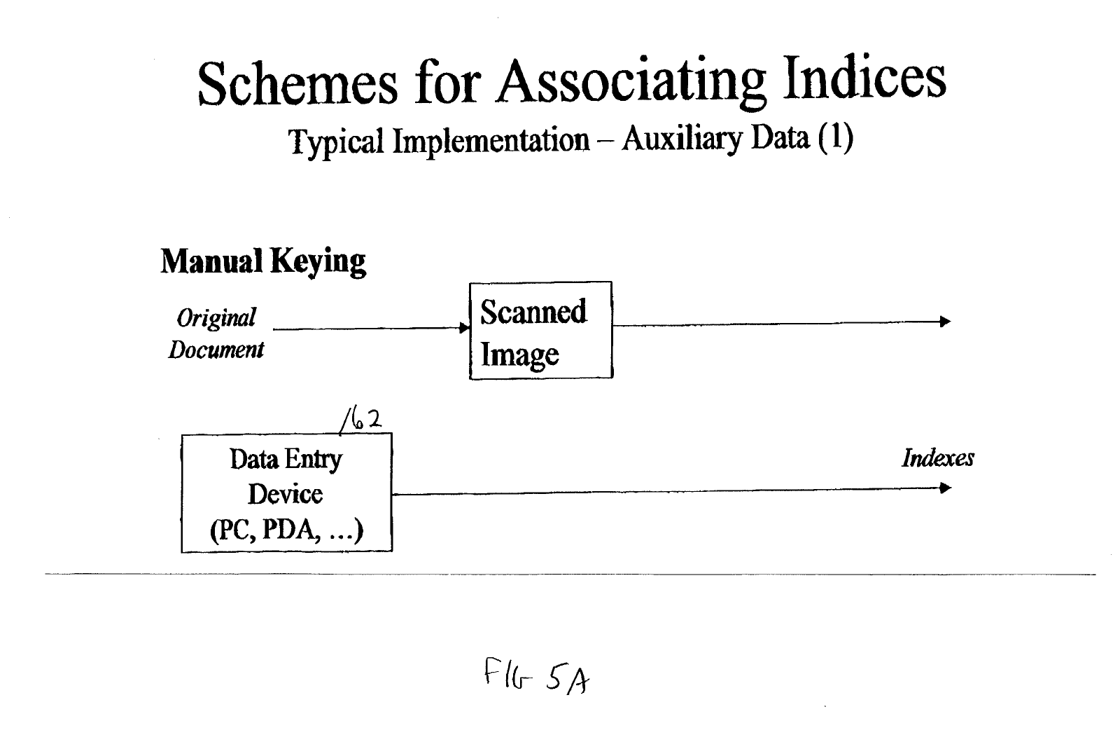

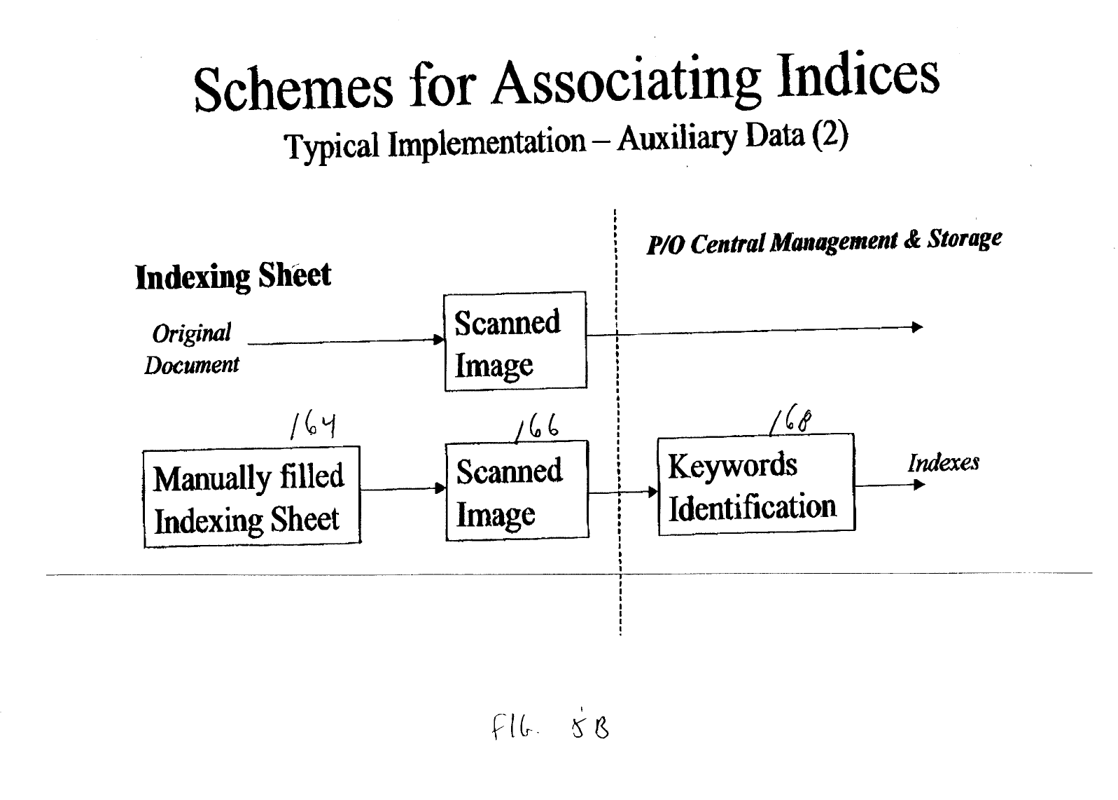

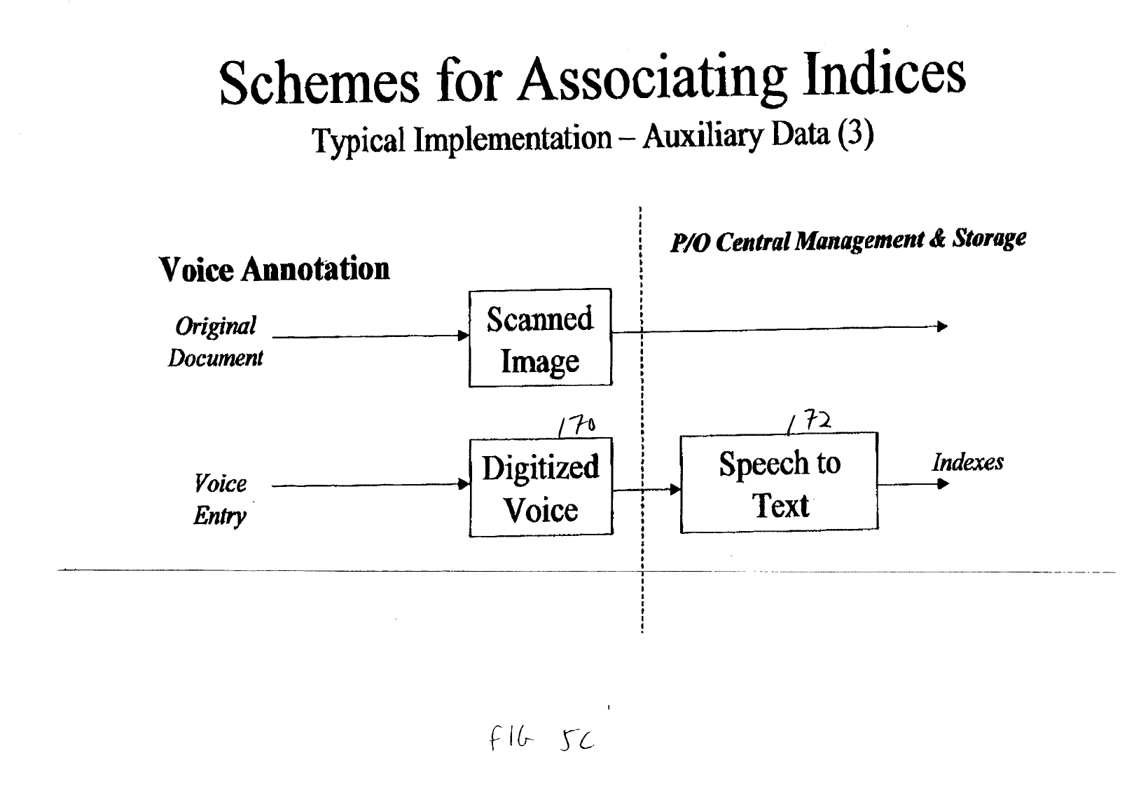

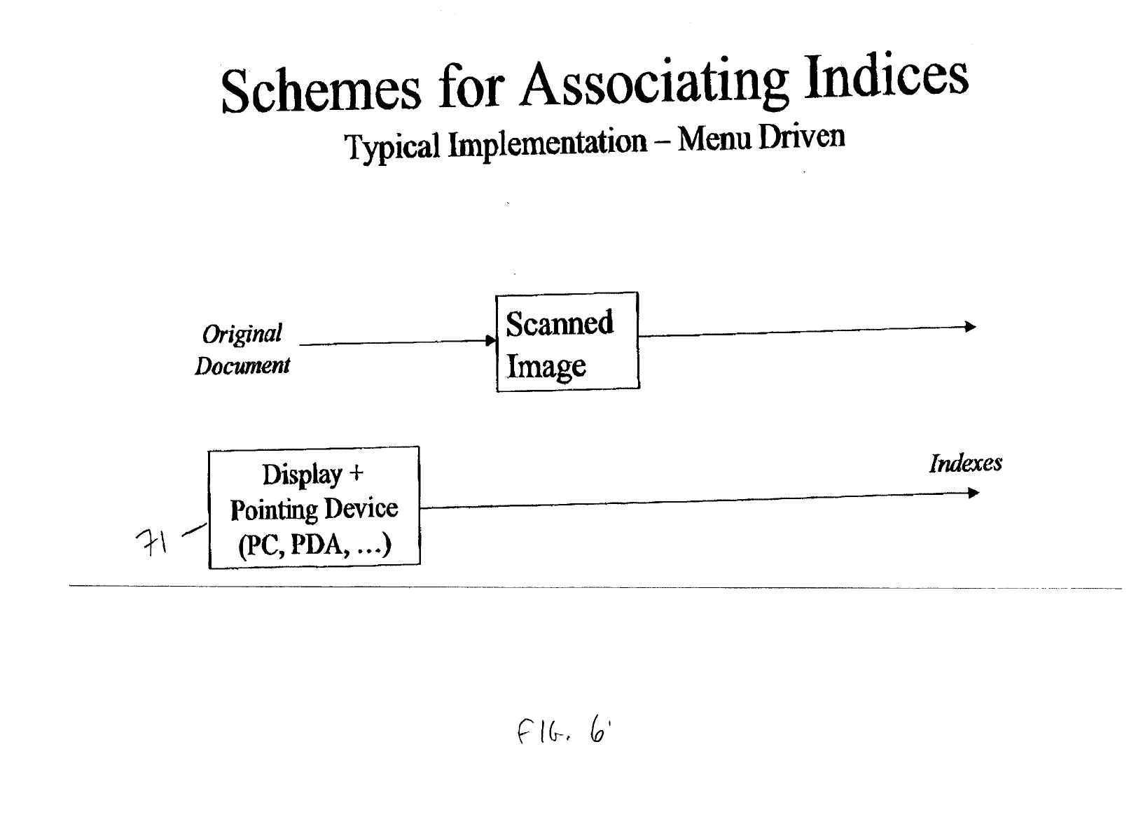

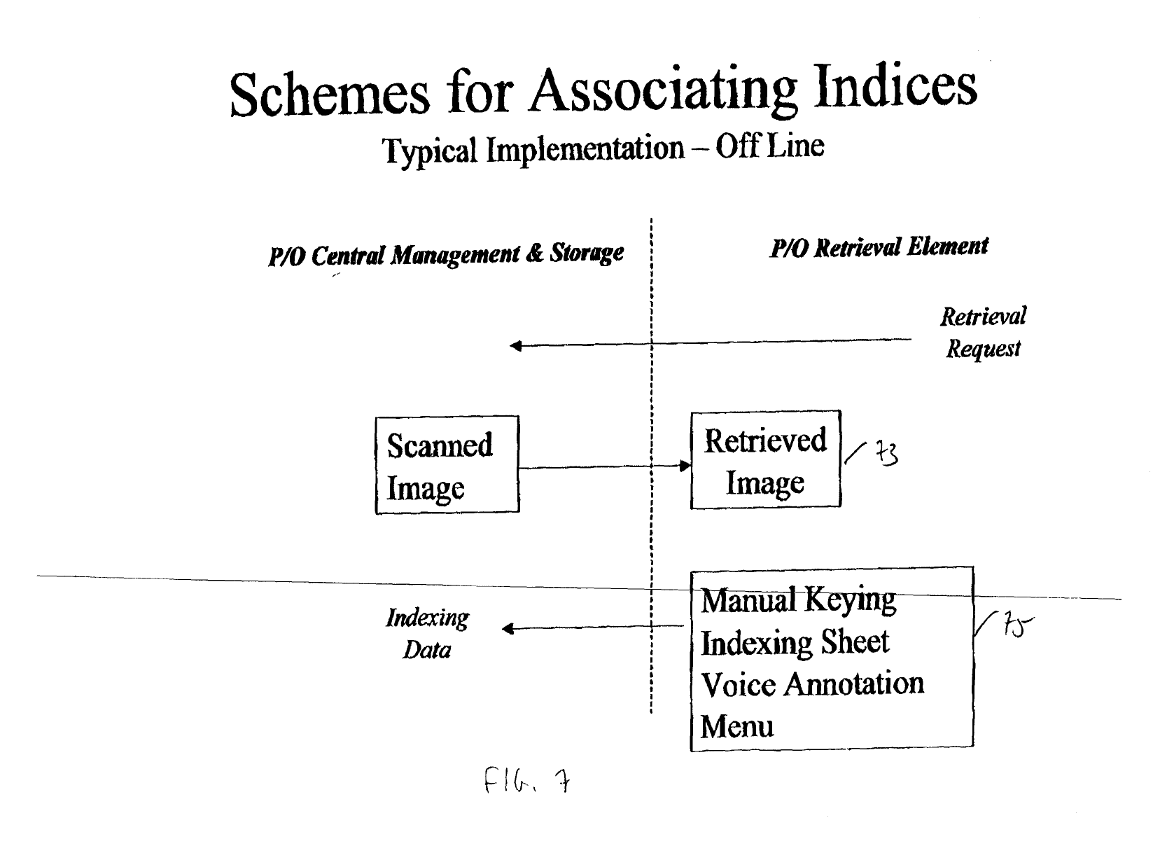

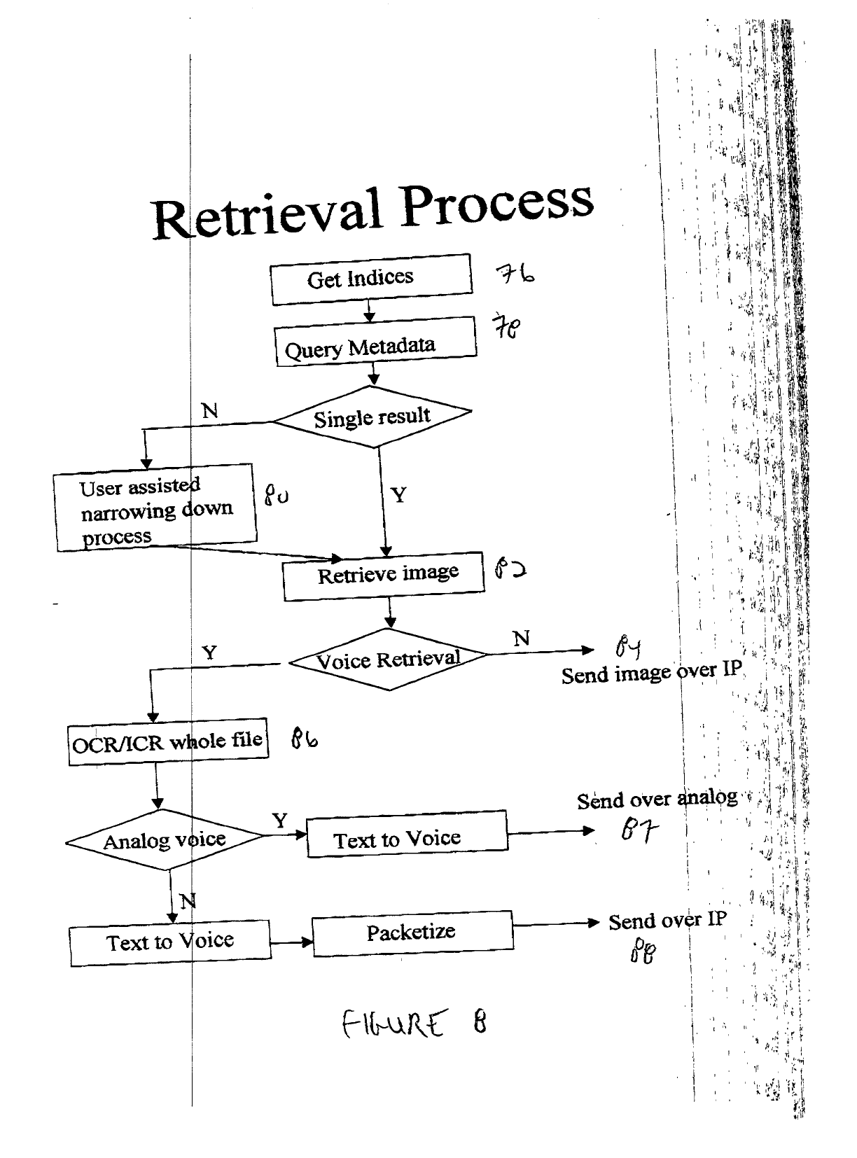

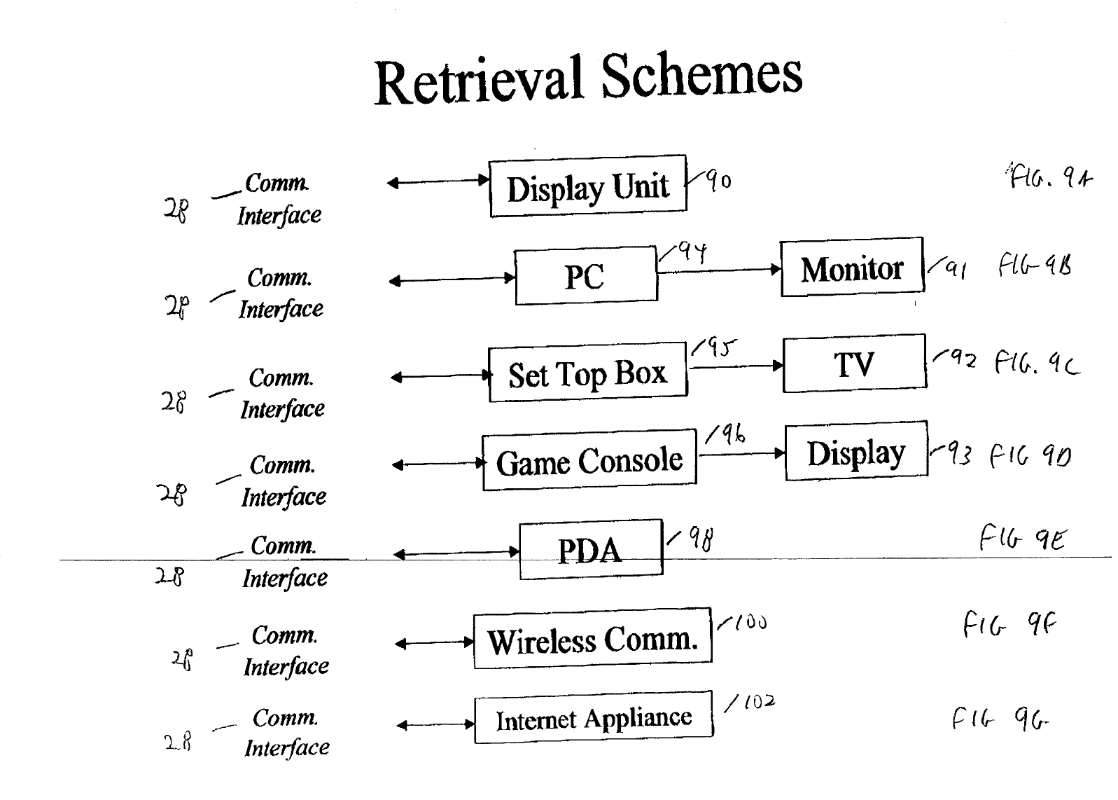

FIGS. 4a-4c show sample embedded data schemes where the index words are embedded in a document 46 to be scanned.

In FIG. 4a, original document 52 including keywords is scanned to give scanned image 54 which is sent to CMSE 14. When CMSE 14 receives scanned image 54, CMSE 14 recognizes pre-defined keywords so that CMSE 14 is able to associate the correct index/indices with the archived scanned image 54 . Keyword identification techniques 53 include OCR, and intelligent character recognition (ICR). An exemplary product for ICR is Cleqs, manufactured by gentriqs Software, AG, headquartered in Eltville, Germany. It should be evident that under the scheme of FIG. 4a, the indices specified by the user must be limited to allowed (predefined) indices (i.e. keywords) either common to all users or previously individualized for that user.

In FIG. 4b, index words receive a manual highlight 56 in original document 52. When CMSE 14 receives scanned image 54 of original document 52, CMSE 14 uses highlight identification techniques 58 based on image processing (for example, using an analysis package such as “Digital image Processing” by WOLFRAM Research Inc. of Champaign, Ill.) to locate the index fields, and subsequently uses technologies such as OCR or ICR to recognize the indices.

FIG. 4c illustrates a scheme where index words are located in a specific location (field) of the document (i.e. a certain field in the document is filled in and its content is interpreted as an index word). CMSE 14 performs field identification techniques 60 such as image processing, form processing, OCR, or ICR to recognize and/or uncover the indices. The field scheme could be used, for example, when handling repeatable forms—for example for bank statements. Once the standard form type is identified, the “month” field (as an example)—which is generally in the same place on each statement—can be automatically extracted for index purposes. Examples of products that may provide the technological foundation for such functions are AFSPRO and FREEDOM, developed by Top Image Systems Ltd. from Tel-Aviv, Israel. It should be noted that with technologies such as those implemented in FREEDOM, the forms need not necessarily be of a standard repeatable type, known to the system.

FIGS. 5a to 5c show typical schemes in which auxiliary data is used for associating indices with documents—i.e. where index words, are transmitted to CMSE 14 separately from the original document. It should be evident that auxiliary data can be transmitted immediately prior to or immediately following the original document, or the auxiliary data can be transmitted at a different session. For example, a user may log on to the remote location, request to see recently scanned yet un-indexed document, and subsequently enter and send the auxiliary indexing data. Another example is a user who asks a third party to scan and transmit a document to the user, and the user retrieves the document at a later time and associates index words with it.

In certain embodiments, CMSE 14 maintains a list of documents with which no index words are associated, in order to alert the user and enable off-line (i.e. in a separate session, not the same as the one in which scanning the document takes place—see FIG. 7) user assistance including but not limited to corrective action in which the user will enter indices using the appropriate scheme for associating indices with a document.

In the case of a downloaded file sent directly to CMSE 14, the index words (auxiliary data) need not be separately entered by a user but may be generated automatically, based on the scheduled event which triggered the download or based on the source (i.e. web site) from which the file was downloaded. However, if the user so desires—he may add, delete and/or modify the indices in an off-line session,

FIG. 5a shows an auxiliary data scheme using manual keying. Indices are indicated (i.e. entered) via a data entry device 62 such as a personal computer (keyboard, mouse, etc), game console, personal digital assistant, or archiving device 32 with input module 47, etc. The auxiliary data is transmitted to CMSE 14 where the data is use to index a scanned image.

It should be evident that distinct entered codes can indicate whether the auxiliary data refers to one or more images sent immediately prior, to be sent subsequently, or sent at in a different session.

FIG. 5b illustrates a second scheme using auxiliary data to associate index words with a scanned image. A manually filled scanning sheet 64 is scanned to give a scanned image 66. Scanned image 66 is transmitted to CMSE 14 and CMSE 14 performs keyword identification techniques 68 such as OCR or ICR to recognize and correctly index the separately scanned original document. Preferably, a user can write the words in a legible hand on any available background (e.g. loose-leaf index card, envelop label, etc.) for use as scanning sheet 64.

FIG. 5c shows a scheme where voice annotation is used as auxiliary data. A user indicates (i.e. speaks) index words into a microphone connected to a device which can connect to communication interface 22 such as a personal computer, personal digital assistant, etc, or a user indicates index words to archiving device 32 with microphone module 51. The voice is converted to digitized voice 70 so that it can be transmitted as packets over the data network. When CMSE 14 receives the communication, CMSE 14 performs a speech recognition algorithm 72, converting speech to text so as to obtain indices.

Clearly, errors may occur in the processes described above with reference to FIGS. 5a-5c. For example, the user might perform an error while typing in an index word in the manual keying scheme, CMSE 14 might fail to correctly recognize a printed index word in the indexing sheet scheme, or the CMSE might fail in performing the text to speech in the voice annotation scheme (alternatively, the user might perform an error—for example, writing or saying an index word that has not been defined for usage). In these cases the CMSE will prompt the operator for user assistance including but not limited to corrective action. Such prompting will include presenting the user with the unrecognized index word that resulted from the CMSE processing, along with—if possible—the input that was used to derive the erroneous result (for example, the image of the word that was OCR'ed, or the digitized voice that was converted to text). The user's corrective action will usually consist of deleting the erroneous word, and possibly entering a correct one (or more than one). In some implementations, the user might be required to review and confirm the interpretation of indices by CMSE 14, even if no evident problems were identified during the process.

The user assistance/corrective action can take place either in real time (if feasible, i.e. two way communications with capture element 12 is supported and enabled) or at a later session upon connection to retrieval element 16.

FIG. 6 shows a scheme for associating index words with a document that is menu driven. A display and pointing device 71, for example a personal computer, game console, PDA, or archiving device 32 with input module 47 and display module 50, etc. is used to display menu choices to the user and to allow the user to indicate (select) appropriate indices to be associated with the scanned image of his document.

FIG. 7 illustrates the process of associating index words with a document at a later session (or off-line, as referred to in this document). A user retrieves stored image 73 (the retrieval process is described below) and associates index words with the document e using manual keying, indexing sheet, voice annotation, or a menu as described above with reference to FIGS. 5a, 5b, 5c, and 6. CMSE 14 transmits the image files with no index words associated with them either automatically upon identification of the user, or in response to a specific request.

Once associating indices function 20 (FIG. 1) is performed, the indices are stored by CMSE 14 as part of the meta-data associated with the document, and are used to identify the required document during retrieval operation 30. Hereinafter, meta-data is defined as data which describes other data. In the context of the invention, meta-data includes but is not limited to a list of indices and time of storage of a document.

The retrieval process will now be described with reference to FIG. 8. Once a document and its associated meta-data are stored, a user can access a document and view the digitized image using any web-enabled device that has an appropriate display. Such device might be a PC, a set top box connected to a TV, a game console connected to a display (TV or other), a web enabled phone, an Internet appliance, etc. Note that the displayed image may be adapted to the specific device being used—for example a colored document may be displayed in B&W, resolution may be degraded to fit the characteristics of the display element, etc.

To retrieve the desired document, the user specifies a list of indices generally through the browser of a web enabled device (step 76), however, the requested file can be specified by indices entered from a phone keypad (DTMF tones) or cellular telephone through voice gateway 15 or through other input devices.

Subsequently, in step 78, CMSE 14 searches through the meta-data of all stored files looking for all documents that have associated with them all the indices specified in the user's request. If more than one stored document has all the specified indices as part of its associated meta-data, the user is presented with basic information (such as date and time of storage, first line of the document, etc) on all relevant documents. The user may then select a particular document for retrieval, or may step through the whole list, viewing each document sequentially (step 80).

As evident from the description above, in the case of retrieval—unlike in that of capture—two way communications between retrieval element 16 and CMSE 14 is usually necessary. However, for embodiments where a browser is used with any web enabled device for retrieval element 16, the implementation of retrieval element 16 is straight forward and does not require any special hardware or software.

The document is then retrieved by CMSE 14 (step 82). If the user (through retrieval element 16) elects for image retrieval mode, the image file is sent over IP (step 84).

FIGS. 9a-9f show sample retrieval systems for accessing documents whose image files are stored in CMSE 14.

FIG. 9a shows a display 90 controlled by an embedded controller with display 90 directly connected to communication interface 28. Preferably display 90 is identical to display module 50 which is part of archiving apparatus 32 (FIG. 3).

FIG. 9b shows a retrieval system including a monitor 91 connected through a personal computer 94 to communication interface 28.

FIG. 9c illustrates a retrieval system using a television 92 connected through a set top box 95 to communication interface 28.

In FIG. 9d, a display 93 is connected to communication interface 28 through a game console 96.

FIG. 9e illustrates a retrieval system using a personal digital assistant 98 connected to communication interface 28.

FIG. 9f illustrates another embodiment of the retrieval system, using a Web enable cellular phone 100.

FIG. 9g illustrates another embodiment of the retrieval system, using an Internet appliance 102.

In case retrieval element 16 does not contain (or is not connected to) a hard copy element such as a printer, then—for retrieval elements 16 which are web enabled—it ill be possible to send the image of the retrieved document to a device where it may be printed, for example, as an e-mail attachment sent to a full featured PC workstation. This operation will be performed as part of the basic capabilities of the user's environment.

In FIGS. 9b to 9e, connections between peripherals 91, 92, or 93 and PC 94, set top box 95, and game console 96, may be wired connections (e.g. cables), or wireless (for example using the Bluetooth protocol).

In some of the examples outlined above communications interface 28 might include dedicated hardware and software (as in the case of a modem and appropriate drivers, for example), but in other cases the whole communications interface might be an integral, embedded part of the device being used (as in the case of a WAP enabled cellular phone, for example).

In general, the requested image file is transmitted by CMSE 14 to the location from where the request initiated. However, retrieval element 16 (for example through a web browser) may allow a user to specify that a stored image file be sent to another location. It is evident that retrieval element 16 must be coupled to or incorporated into an output device such as a display, printer, television, web enabled cellular telephone, etc. Alternatively, or in addition to, retrieval element 16 may be capable of locally storing the received image file for subsequent access.

As an alternative or in addition to outputting and/or storing the retrieved document, retrieval element 16 may define the indices to be used by CMSE 14—and once the document is found, instruct CMSE 14 to send the retrieved image to another device—for example, as an attachment sent to an e-mail address, or as a fax sent to a certain number (through fax gateway 13).

According to preferred embodiments of the present invention, retrieval methods also include voice retrieval and summary retrieval.

In the voice retrieval mode, the document contents (after OCR/ICR—step 86) are text-to-voice converted, and “played” to the user as an audio (voice) “file”. It should be evident that a file that is text to voice converted for playing back to a user may have originally been a voice file (converted voice to text at the capture stage) or may have originally been an image file at the capture stage. In other embodiments where the file was initially digitized and stored as a digital voice file (see above), no text to voice conversion is necessary. This playback can be performed either using an analog audio output (for example, to be transmitted to the user over POTS or cellular phone) (step 87) or as digitized output (step 88) (for example, packets of VoIP—voice over IP—relayed over a network to a computer where they will be converted to analog form and played to the user). Text to speech technology is exemplified fly RealSpeak, manufactured by Lemhout & Hauspie Speech Products, NV, Ieper, Belgium.

An example for usage of voice retrieval mode might be a person, “listening to” (=reading) through a phone a shopping list scanned into the system by his or her spouse. Another example might be a case in which the input is not a scanned paper document but rather a downloaded file—for example, a user driving a car while using his cellular radio to “listen to” (=read) his updated stock portfolio which was automatically downloaded from a web site to his on-line archive.

In summary retrieval mode CMSE 14 may be configured to automatically prepare pre-defined summaries based on contents of stored documents. An example might be monthly summaries of bank statements. To do this CMSE 14 will use data derived from contents of certain fields in individually stored documents.

In certain embodiments, the system described above is implemented by an application service provider (ASP). Optionally, users will be billed based on usage of storage media, number of times data is accessed, amount of memory used by users, special functions, etc. In such embodiments, the process taking place in CMSE 14 also includes a billing system.

While the invention has been described with respect to a limited number of embodiments it will be appreciated that many variations, modifications and other applications of the invention may be made.

What is claimed is:

1. A method for preparing at least one personal document for remote archiving, comprising the steps of:
associating at least one index word with the at least one personal document; and
transmitting at least one file related to the at least one personal document to a remote storage location.

2. The method of claim 1, wherein said at least one index word is transmitted to said remote location in the same session as said at least one file.

3. The method of claim 1, wherein said at least one index word is transmitted to said remote location in a different session than said at least one file.

4. The method of claim 1, wherein said at least one file is an image file of said at least one personal document.

5. The method of claim 4, further comprising the step of:
obtaining said at least one image file.

6. The method of claim 5, wherein said obtaining includes the step of:
scanning said at least one personal document to generate said at least one image file.

7. The method of claim 5, wherein said obtaining includes the step of:
downloading said at least one image file from a web site on the world wide web.

8. The method of claim 7, wherein said downloaded image file is directly transmitted from said web site to said remote storage location.

9. The method of claim 8, wherein said downloading and direct transmitting occurs upon a user defined condition being met.

10. The method of claim 1, wherein said at least one file is a voice file of said at least one personal document.

11. The method of claim 1, wherein said at least one index word is embedded in said at least one file.

12. The method of claim 11, wherein said at least one index word is embedded in said at least one file using a technique selected from the following group that includes: manual highlighting, field completion, and keyword usage.

13. The method of claim 1, wherein said at least one index word associated with said at least one personal document is indicated using a technique selected from the following group that includes: manual keying, scanning, selecting from a menu, and speaking.

14. A method for remotely archiving at least one personal document comprising the steps of:
receiving from a remote site at least one file related to the at least one personal document;
associating at least one index word with said at least one file; and
storing said at least one file.

15. The method of claim 14, further comprising the step of:
receiving at least one index word associated with said at least one file.

16. The method of claim 15, wherein at least one index word associated with said at least one file is identical to said at least one received index word.

17. The method of claim 15, further comprising the step of:
identifying said at least one received index word through a technique selected from the following group that includes: keyword identification, highlight identification, field identification, and speech recognition.

18. The method of claim 15, further comprising the step of:
prompting the transmitter of said at least one received index word for user assistance.

19. A method for requesting the retrieval of at least one remotely archived file related to a personal document, comprising the steps of:
specifying at least one index word; and
receiving the at least one file associated with said at least one specified index word.

20. The method of claim 19, further comprising the step of:
outputting the at least one file.

21. The method of claim 20, wherein said outputting includes the step of displaying the at least one file.

22. The method of claim 20, wherein the at least one received file is outputted as an audio output.

23. The method of claim 19, further comprising the step of:
selecting the at least one file for receiving from among more than one file associated with said at least one specified index word.

24. The method of claim 23, wherein said selecting is performed using a web browser.

25. The method of claim 19, wherein the at least one file includes a summary of at least some of the information included in the at least one personal document.

26. A method of retrieving at least one remotely archived file, related to at least one personal document, comprising the steps of:
receiving at least one index word associated with said at least one remotely archived file;
retrieving said at least one remotely archived file from storage; and
transmitting said retrieved at least one file.

27. The method of claim 26, further comprising the step of: prompting for user assistance.

28. A system for remotely archiving at least one personal document, comprising:
at least one processing element for associating at least one index word with at least one file related to the at least one personal document; and
at least one storage element for storing said at least one file based on said associating.

29. The system of claim 28, wherein said system is coupled to the Internet.

30. The system of claim 28, further comprising at least one fax gateway for receiving said at least one file.

31. The system of claim 28, further comprising at least one voice gateway for receiving said at least one file.

32. A system for preparing at least one personal document for remote archiving, comprising:
at least one communication interface; and
at least one device for specifying at least one index word associated with the at least one document, coupled to said at least one communication interface.

33. The system of claim 32, wherein said at least one device includes at least one device selected from the group that includes: a data entry device, a microphone, a scanner, and a display and pointing device.

34. The system of claim 32, further comprising:
at least one scanner for generating at least one file, wherein said at least one file is an image file of the at least one document.

35. The system of claim 34, wherein said at least one scanner is part of at least one archiving device which includes at least one controller.

36. The system of claim 34, wherein said at least one scanner is a peripheral to at least one another device coupled to said at least one communication interface.

37. The system of claim 36 wherein said at least one another device is selected from the group that includes: a personal computer, a set top box, a game console, a personal digital assistant, a wireless device, and an internet appliance.

38. A system for retrieving at least one remotely archived file related to at least one personal document comprising:
at least one storage element for storing the at least one file related to the at least one personal document; and
at least one searching element for searching said at least one storage element for the at least one file.

39. The system of claim 38, wherein said system is coupled to the Internet.

40. The system of claim 38, further comprising at least one voice gateway.

41. The system of claim 38, further comprising at least one fax gateway.

42. A system for requesting the retrieval of at least one remotely archived file related to at least one personal document, comprising:
at least one communication interface; and
at least one device coupled to said at least one communication interface for specifying at least one index word associated with the at least one document.

43. The system of claim 42, wherein said at least one device is a web enabled device.

44. The system of claim 42, further comprising
at least one output device for outputting the at least one file

45. The system of claim 44, wherein said at least one output device is selected from the group of: a display unit, a monitor, a TV, a personal digital assistant, a wireless communication device, and an internet appliance.

46. The system of claim 44, wherein said at least one output device is directly coupled to said at least one communication interface.

47. The system of claim 44, wherein said at least one output device is a peripheral of at least one another device coupled to said at least one communication interface.

48. The system of claim 47, wherein said at least one another device is selected from a group of a personal computer, a set top box, and a game console.

49. A method of providing a remote archiving service to individual users by an application service provider, comprising the steps of:
users registering for remote archiving service;
users using remote archiving service; and
users being billed based on their usage.

50. The method of claim 49, wherein usage includes the number of hours connected to a site of the application service provider.

51. The method of claim 49, wherein usage includes the frequency of logging on to a site of the application service provider.

52. The method of claim 49, wherein usage includes the amount of memory allocated to individual users.

53. An apparatus for capturing and feeding a document to a remote archiving system, comprising:
a controller; and
a scanner module coupled to said controller.

54. The apparatus of claim 53, further comprising a communications module coupled to said controller.

55. The apparatus of claim 53, further comprising an audio processing module coupled to said controller.

56. The apparatus of claim 53, further comprising a display module coupled to said controller.

57. The apparatus of claim 53, further comprising an input module coupled to said controller.

58. The apparatus of claim 53, further comprising an output module coupled to said controller.

59. The apparatus of claim 53, further comprising a hard copy interface coupled to said controller.
